(19) United States
(12) Patent Application Publication
(10) Pub. No.: US 2003/0101654 A1
(43) Pub. Date: Jun. 5, 2003

(54) Compact cable-type window lifter

(76) Inventor: Fabien Dufour, Chateauneuf Sur Loire (FR)

Correspondence Address: CARLSON, GASKEY & OLDS, P.C., 400 WEST MAPLE ROAD, SUITE 350, BIRMINGHAM, MI, 48009, US

(21) Appl. No.: 10/300,463

(22) Filed: Nov. 20, 2002

(30) Foreign Application Priority Data
Nov. 29, 2001 (FR) 01 15 443

(51) Int. Cl. E05F 11/48

(52) U.S. Cl. 49/352

(57) ABSTRACT

This invention relates to a window lifter comprising a window connecting element; a cable drive motor element, offset from the travel of the connecting element, a first and a second cable return which returns are arranged at one end of the travel of the connecting element and superposed, a third cable return arranged at another end of the travel of the connecting element, a cable secured to the window connecting element. This window lifter has, in particular, greater compactness.

This application claims priority to French application No. 01 15 443 filed on Nov. 29, 2001.

### BACKGROUND OF THE INVENTION

The invention relates to window lifters for motor vehicles and more particularly to motor vehicle window lifters with cable returns.

U.S. Pat. No. 4,910,917 discloses a cable type window lifter. This window lifter comprises two non-parallel rails guiding two respective sliders in a window-moving travel. Each slider is driven by a Bowden cable. Each slider has two parts. A first part is guided by the rail and a second part is fixed to the window. The two parts slide relative to one another in translation and in rotation. This device allows the relative position of the two parts to be adjusted to prevent the window from being braced against a window frame.

This device has disadvantages. It occupies a significant area projected onto the mid-plane of the window. This device also entails the use of two guide rails.

There is therefore a need for a window lifter that solves one or more of these drawbacks.

### SUMMARY OF THE INVENTION

The subject of the invention is thus a window lifter comprising a window connecting element, a cable drive motor element, offset from the travel of the connecting element, a first and a second cable return which returns are arranged at one end of the travel of the connecting element and superposed, a third cable return arranged at another end of the travel of the connecting element, and a cable secured to the window connecting element.

According to an alternative form, the cable is guided in succession by the first return, the motor element, the second return and the third return.

According to yet another alternative form, of the first and second returns, one is a pulley.

According to another alternative form, the first and second returns are pulleys.

According to yet another alternative form, the first and second pulleys are mounted to rotate about the same axis.

Provision may alternatively be made for the pulley to have two grooves forming first and second returns respectively.

According to an alternative form, the two pulleys or grooves have different diameters.

According to another alternative form, the diameter of one pulley or groove is defined so that the cable between this pulley or groove and the third return remains parallel to the travel of the connecting element.

According to yet another alternative form, the diameter of the other pulley or groove is defined so that the cable between the other pulley or groove and the connecting element remains parallel to the travel of the connecting element.

Other features and advantages of the invention will become apparent from reading the description which follows of some embodiments of the invention, which is given by way of example with reference to the appended drawings which show:

### BRIEF DESCRIPTION OF THE DRAWINGS

FIG. 1 a schematic depiction of one example of a window lifter according to the invention;

FIG. 2 a view in cross section of a double return of FIG. 1;

FIG. 3 a front view in cross section of details of the window lifter of FIG. 1; and

FIG. 4, a view from above of details of the window lifter of FIG. 1.

### DETAILED DESCRIPTION OF THE PREFERRED EMBODIMENT

The invention relates to a window lifter having a connecting element, a motor element offset from the travel of the motor element and two superposed returns arranged at one end of the travel.

In that which follows, two superposed returns are to be interpreted as being two returns which overlap at least in part, when considered in a direction normal to the plane of the return, and the planes of which are substantially parallel but separate. The plane of a return is defined by the plane which includes the cable parts entering and leaving a return.

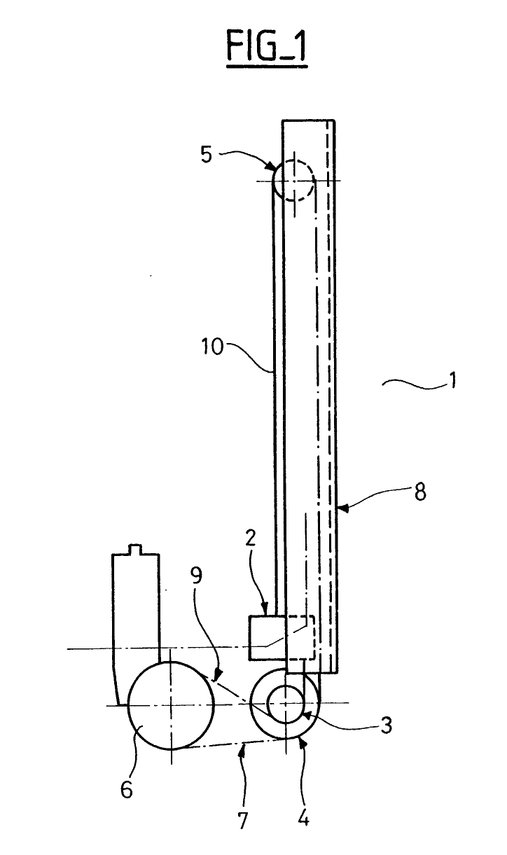

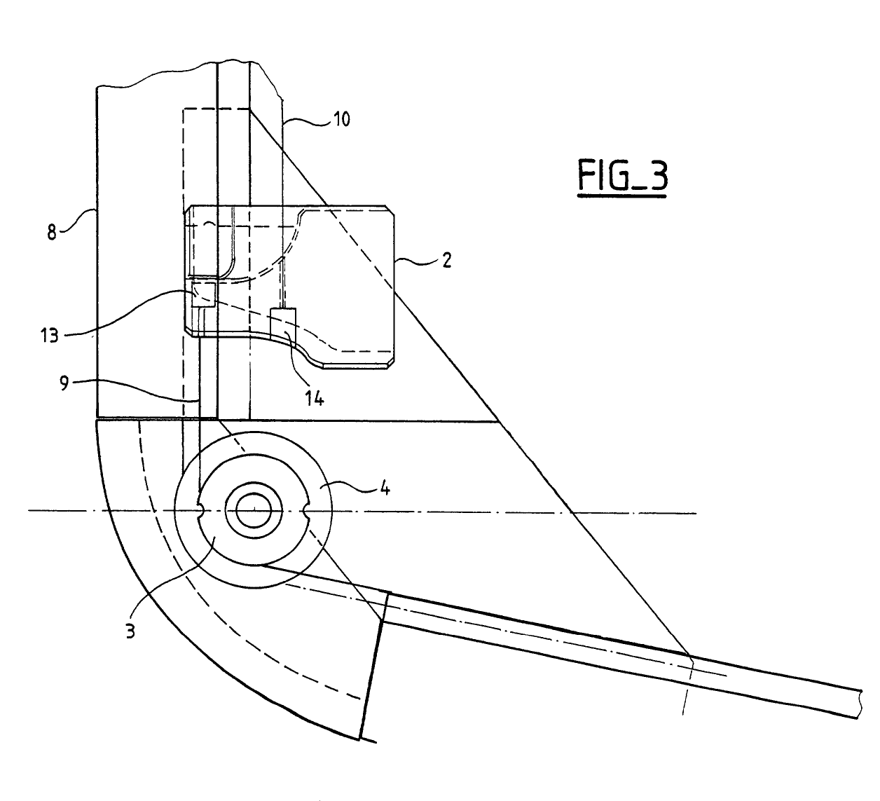

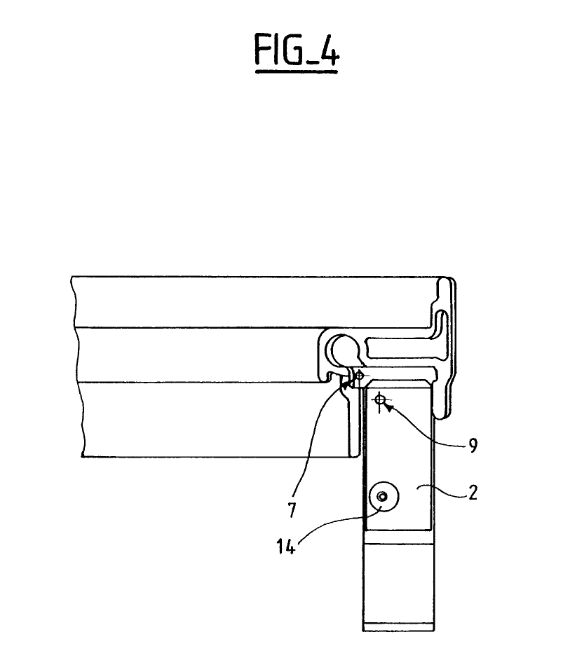

FIGS. 1 to 4 depict one example of a window lifter 1 according to the invention. This window lifter 1 comprises, in particular, a window connecting element 2. A window to be moved, depicted in chain line in FIGS. 1 and 3, is secured to the connecting element 2. The window connecting element is mounted to slide with respect to a guide rail 8. A cable 7 has two ends 9 and 10 secured to the connecting element by the lower part and by the upper part respectively. The window lifter has a return 5 arranged at one end of the travel of the connecting element and two superposed returns 3 and 4 arranged at the other end of the travel of the connecting element. A motor element 6 driving the cable is arranged offset from the travel of the connecting element 2. A cable-tensioning system, not depicted, may be fitted, to keep the cable taut.

The return 3 deflects the path of the end of the cable 9 which end is intended to apply a downwards force on the connecting element 2. The return 4 deflects the path of the end of the cable 10 which end is intended to apply an upwards force on the connecting element. The returns 3 and 4 are superposed. Thus, the space occupied by the window lifter in the mean plane defined by the cable is smaller. In addition, when the motor element comprises a winding drum which has a helical groove, it may prove particularly advantageous to use superposed returns. By arranging the superposed returns 3 and 4 opposite the cable parts leaving the groove, the cable parts leaving the groove can run with the smallest deflection of their path as far as the respective returns 3 and 4. The cable is then not stressed as much in the direction normal to the plane of the returns, and this reduces the friction of the cable on the returns.

In the example depicted, the cable is fixed by its end 10 to the window connecting element 2, then runs in succession over the return 5, the return 4, through the motor element 6, over the return 3 and is fixed by its end 9 to the connecting element 2. The three cable parts arranged in the path of the connecting element, that is to say between the returns 5 and 3-4, thus occupy a particularly compact volume, which makes it possible to free up space, for example, in a door in which the window lifter may be mounted. In this arrangement, and because the returns 3 and 4 are superposed, the cable parts running between the motor element and the returns 3 and 4 also occupy a particularly compact amount of space.

In an advantageous alternative form of the invention, at least one of the returns 3 or 4 is produced in the form of a pulley. By mounting such a pulley for example so that it can rotate with respect to a structural part 11 of the window lifter, friction between the pulley and the cable that it guides is reduced.

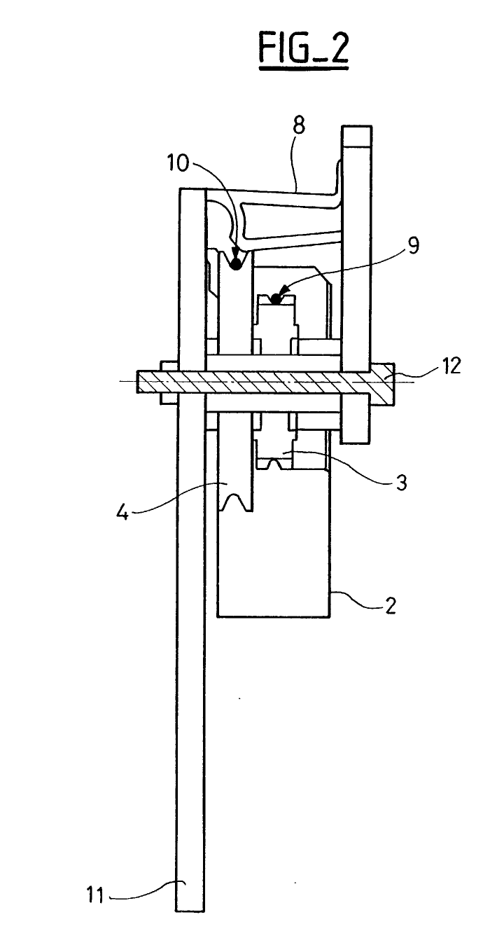

As depicted in FIG. 2, it is also possible to envisage using two returns 3 and 4 in the form of pulleys. It is then preferable to use a common axis for the pulleys. It is, for example, possible to envisage mounting the pulleys 3 and 4 about one and the same shaft 12 which guides their rotation. The structure and the mounting of the window lifter are thus simplified. Although pulleys 3 and 4 with a common axis have been depicted, it is also possible to envisage pulleys with offset respective axes. It is, for example, possible to envisage mounting the pulleys 3 and 4 to rotate about respective shafts.

In the example depicted, the pulleys 3 and 4 have different diameters. The pulley 3 thus has a diameter smaller than the diameter of the pulley 4. Thus, the cable part running between the return 4 and the return 5 can run outside the volume swept by the connecting element in its travel. This then avoids rubbing between the cable and the connecting element.

In the example depicted, use is made of a guide rail which has a guide slot for guiding the connecting element. As can be seen in FIG. 1, the cable part between the returns 4 and 5, and the cable part between the return 5 and the connecting element remain contained in the volume of the slotted part of the rail. These cable parts are thus protected by the rail and arranged inside a compact volume. This protection advantageously makes it possible to dispense with a sheath.

It is also possible to envisage using pulleys 3 and 4 just one of which is mounted to rotate with respect to the window lifter structure 11, while the other pulley is fixed. It is also possible to envisage a single two-grooved pulley to reduce the number of components in the window lifter. The pulley is then mounted to rotate with respect to the structure of the window lifter. The pulley will then turn in the same direction as a first part of the cable that it guides and in the opposite direction to another cable part that it guides. The pulley is preferably designed to rotate in the same direction as the cable part intended to exert an upwards force on the connecting element.

It is also possible to superpose a return in the form of a pulley mounted so that it rotates with a return which is fixed with respect to the structure. It is then possible, as appropriate, to use an element of the rail as a cable return. The pulley is preferably used to guide the cable that exerts the upwards force on the connecting element.

FIG. 3 depicts details of the connecting element 2. The connecting element 2 has fixing elements 13 and 14 to fix the ends of the cable 9 and 10 respectively. The distance between the fixing elements 13 and 14, projected onto a straight line perpendicular to the travel of the connecting element within a plane of a return, is more or less equal to the distance, in the same projection, between a point of end of contact of the return 3 with the cable and a point of end of contact of the return 5 with the cable. Thus, the cable parts running respectively between the return 3 and the connecting element 2 and between the return 5 and the connecting element 2, remain parallel throughout the movement of the slider. Thus cable deflection is reduced. Cable wear and noise are thus reduced.

Although in the example depicted, use is made of one guide rail, it is of course possible to envisage within the context of the invention for the window lifter to be free of a rail. It can then be envisaged for the connecting element to be guided by appropriate tension in the cable parts running between the pulleys 5 and 3-4.

Furthermore, although just one window connecting element has been described in the window lifter presented, it is just as easy to envisage a second connecting element with a travel more or less parallel to that of the connecting element described. It is thus possible to envisage for another cable, driving the other connecting element, also to be coupled to the motor element 6.

Of course, the present invention is not restricted to the exemplary embodiments described and depicted but can be varied in numerous ways accessible to those skilled in the art. It is thus possible to envisage for the cable 7 to be split into several independent cables. It is possible to envisage coupling the independent cables, for example, at the motor element.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A window lifter comprising:
a window connecting element;
a cable drive motor element, offset from a travel path of said connecting element;
a first cable return and a second cable return which are arranged at one end of said travel path of the connecting element and at least partially superposed;
a third cable return arranged at another end of said travel path of said connecting element; and
a cable secured to said window connecting element.

2. The window lifter as recited in claim 1, wherein said cable is guided in succession by said first cable return, said motor element, said second cable return and said third cable return.

3. The window lifter as recited in claim 1, wherein at least one of said first cable return and said second cable return is a pulley.

4. The window lifter as recited in claim 3, wherein both of said first cable return and said second cable return are pulleys.

5. The window lifter as recited in claim 4, wherein said first cable return and said second cable return are mounted to rotate about a same axis.

6. The window lifter as recited in claim 4, wherein said first cable return has a first diameter and said second cable return has a second diameter, and said first diameter is different than said second diameter.

7. The window lifter as recited in claim 6, wherein one of said diameters of one of said cable returns is defined so that said cable between said cable return and said third cable return remains parallel to said travel path of said connecting element.

8. The window lifter as recited in claim 7, wherein said diameter of the other cable return is defined so that said cable between said other cable return and said connecting element remains parallel to said travel path of said connecting element.

9. The window lifter as recited in claim 1, further including a pulley having two grooves, said two grooves forming said first cable return and said second cable return.

10. The window lifter as recited in claim 9, wherein said first groove has a first diameter and said second groove has a second diameter, and said first diameter is different than said second diameter.

11. The window lifter as recited in claim 10, wherein one of said diameters of one of said grooves is defined so that said cable between said groove and said third return remains parallel to said travel path of said connecting element.

12. The window lifter as recited in claim 11, wherein said diameter of the other groove is defined so that said cable between said other groove and said connecting element remains parallel to said travel path of said connecting element.
